(19) United States
(12) Patent Application Publication
(10) Pub. No.: US 2006/0038412 A1
(43) Pub. Date: Feb. 23, 2006

(54) Door opening and closing assisting device and method

(76) Inventors: Kenji Muramatsu, Nagano (JP); Katsuhiko Hayashi, Nagano (JP); Kiyotsugu Takasawa, Nagano (JP)

Correspondence Address: CANTOR COLBURN, LLP, 55 GRIFFIN ROAD SOUTH, BLOOMFIELD, CT, 06002, US

(21) Appl. No.: 11/205,989

(22) Filed: Aug. 17, 2005

(30) Foreign Application Priority Data
Aug. 23, 2004 (JP) 2004-242758
Feb. 9, 2005 (JP) 2005-033624

(51) Int. Cl. E05C 1/06

(52) U.S. Cl. 292/144

(57) ABSTRACT

An embodiment of the apparatus relates to a door opening and closing assisting device comprising: a spring force to urge the door in a closed direction when the door is half-opened or less and supplies no closing force when the door is more than half-opened. The assisting device is housed either in the door or the main body. The method relates to assisting in opening and closing a door comprising: elastically deforming a spring in response to the door being opened to a half-opened position; disconnecting the spring force if the door is more than half-opened and reconnecting the spring force to the door when the door is half-opened or less.

### CROSS REFERENCE TO RELATED APPLICATION

The present invention claims priority under 35 U.S.C. §119 to Japanese Application No. 2004-242758 filed Aug. 23, 2004 and Japanese Application No. 2005-33624 filed Feb. 9, 2005, which are incorporated herein by reference.

### FIELD OF THE INVENTION

An embodiment of the present invention may relate to a door opening and closing assisting device for assisting closing of a door in a refrigerator or the like.

### BACKGROUND OF THE INVENTION

A conventional door opening and closing assisting device for performing opening and closing of a door in a refrigerator or the like surely is provided with a coil spring which is arranged so as to be laid across the main body of the refrigerator and the door, and the door is urged in the closing direction by the coil spring (see, for example, Japanese Patent Laid-Open No. Sho 57-73384).

In the conventional door opening and closing assisting device, when the urging force of the coil spring is always applied to the door, foods are not be easily put in or taken out from the refrigerator. Therefore, a lever member is required to be utilized to detect and adjust the position of the door and the timing for when the urging force is applied to the door. However, in the case that the coil spring and a timing adjusting mechanism are dividedly disposed in the main body of the refrigerator and the door, the positional relationship between a member disposed on the main body of the refrigerator and a member disposed on the door are required to be arranged with a high degree of accuracy. Therefore, time and effort are required for their assembly and the timing for when the urging force is applied to the door is easily varied.

### SUMMARY OF THE INVENTION

In view of the problems described above, an embodiment of the present invention may advantageously provide a door opening and closing assisting device whose assembly is easily performed and in which a timing for when an urging force is applied to a door is easily set.

Thus, according to an embodiment of the present invention, there may be provided a door opening and closing assisting device for assisting a closing operation of a door which is connected to a main body of an apparatus through a hinge mechanism to open or close an aperture part formed in the main body of the apparatus. The door opening and closing assisting device includes a lever member which swings in cooperation with an opening and closing operation of the door, a first spring member for generating an urging force which is elastically deformed by a swing motion of the lever member when the door is swung in an open direction and which urges the door by an elastic return force of the first spring member in a closing direction through the lever member, and a switching mechanism which mechanically connects the lever member to the first spring member while the door is located between a completely closed position of the door and a half-opened position where the door is swung by a prescribed angle in an open direction from the completely closed position and which disconnects the mechanical connection between the lever member and the first spring member while the first spring member is maintained in a state where the first spring member is forcibly urged and elastically deformed when the door is located at a further opened position from the half-opened position. All of the lever member, the first spring member and the switching mechanism are arranged on one of the door and the main body of the apparatus.

In accordance with an embodiment of the present invention, when the door is opened, the first spring member for generating an urging force is forcibly urged and elastically deformed in a region where the door is swung from the completely closed position to the half-opened position. In addition, when the door is further opened, the switching mechanism disconnects the mechanical connection between the lever member and the first spring member while the first spring member is maintained in a state where the first spring member is forcibly urged and elastically deformed. Therefore, in the state where the door is widely opened, foods can be easily put in and taken out because an urging force is not applied to the door. Further, in the case that the door is closing, when the door reaches to the half-opened position, the switching mechanism connects the lever member and the first spring member in a mechanical manner and thus the urging force of the first spring member is applied to the door. Therefore, the door can be easily and surely closed. In addition, in an embodiment of the present invention, all of the lever member, the first spring member and the switching mechanism are mounted on one of the door and the main body of the apparatus. Therefore, the switching mechanism that adjusts the timing when the position of the door is detected to apply the urging force to the door is constructed on only one side of the door and the main body of the apparatus, and thus assembly can be performed easily and the timing at which the urging force is applied to the door is easily set.

In accordance with an embodiment of the present invention, the lever member, the first spring member for generating an urging force and the switching mechanism are arranged on the main body of the apparatus. According to the construction described above, increase of the size and weight of the door is avoided.

In accordance with an embodiment of the present invention, the switching mechanism includes a first cam part for transmitting an opening and closing operation which is formed in the lever member, a relay member which is displaced by the first cam part to cause the first spring member to be deformed elastically while the door is located between the completely closed position and the half-opened position and which is capable of transmitting an elastic return force generated by the elastically deformed first spring member to the lever member through the first cam part to the door. The switching mechanism also includes a stopper mechanism which permits the disconnection of the mechanical connection between the first cam part and the relay member when the door is located at a further opened position from the half-opened position. The stopper mechanism keeps the first spring member in a state where the first spring member is forcibly urged and elastically deformed by restricting the relay member while the door is located at a further opened position from the half-opened position.

In accordance with an embodiment of the present invention, the stopper mechanism includes a stopper member which keeps the first spring member from generating an urging force on the lever member in the state where the first spring member is forcibly urged and elastically deformed by restricting the relay member when the door is located at a further opened position from the half-opened position, and a second spring member for pressing the stopper member for displacing the stopper member to a position where the relay member is restricted.

In accordance with an embodiment of the present invention, the stopper member is swung around a common rotation center axis to the lever member and is displaced to the position where the relay member is restricted.

In accordance with an embodiment of the present invention, the lever member is provided with a second cam part for pressing the relay member which presses the relay member back to a position to enable a closing operation of the door when the stopper member restricting the relay member is displaced by an external force and releases the restriction of the relay member and the relay member moves to a position obstructing the closing operation of the door.

In this case, the second cam part for pressing the relay member is preferably formed so as to press the relay member back to a position where the relay member is restricted by the stopper member and the stopper member is returned to a state which is capable of restricting the relay member by the second spring member for pressing the stopper member being pressed.

In accordance with an embodiment of the present invention, a damper device is preferably provided, which is mechanically connected to the relay member for generating a load when the door is swung in a closing direction. According to the construction described above, the door can be prevented from closing rapidly.

In accordance with an embodiment of the present invention, it is preferable that the lever member causes the relay member to swing in a direction in which the damper device generates a load when the door is swung in the closing direction. According to the construction described above, even when the door is closed with a large force, since the lever member causes the relay member to swing directly, the door can be prevented from closing rapidly by the operation of the damper device.

In accordance with an embodiment of the present invention, a shutter member is provided which is moved to cover a portion between the door and the main body of the apparatus in cooperation with the lever member when the door is swung in an open direction.

In accordance with an embodiment of the present invention, a transmission mechanism for interlocking the door with the lever member includes a roller and a guide part that guides the roller. According to the construction described above, the swing motion of the door can be smoothly transmitted to the lever member.

As described above, in accordance with an embodiment of the present invention, the first spring member for generating an urging force is forcibly urged and elastically deformed in a region where the door is swung from the completely closed position to the half-opened position when the door is opened and, when the door is further opened, the switching mechanism disconnects the mechanical connection between the lever member and the first spring member while the first spring member is maintained in a state where the first spring member is forcibly urged and elastically deformed. Therefore, in the state where the door is widely opened, foods can be easily put in and taken out because an urging force is not applied to the door. Further, in the case that the door is closing, when the door reaches to the half-opened position, the switching mechanism causes the lever member and the first spring member to connect in a mechanical manner and thus the urging force of the first spring member is applied to the door. Therefore, the door can be easily and surely closed. In addition, in an embodiment of the present invention, all of the lever member, the first spring member and the switching mechanism are mounted on one of the door and the main body of the apparatus. Therefore, since the switching mechanism for adjusting the timing when the position of the door is detected to apply the urging force to the door is constructed only on one side of the door and the main body of the apparatus, assembly can be performed easily and the timing at which the urging force is applied to the door is easily set. As a result, a door can be surely closed in a double swinging doors type of refrigerator or the like.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory view showing a refrigerator in which a door opening and closing assisting device in accordance with an embodiment of the present invention is mounted.

FIG. 2(A) is an explanatory plan view showing the structure of a door opening and closing assisting device in accordance with an embodiment of the present invention, FIG. 2(B) is its longitudinal sectional view, FIG. 2(C) is a sectional view showing a lever member, FIG. 2(D) is a sectional view showing a first spring member for generating an urging force, and FIG. 2(E) is an explanatory view showing an urging force adjustment part.

FIG. 3(A) is a plan view showing a lever member which is used in a door opening and closing assisting device in accordance with an embodiment of the present invention, FIG. 3(B) is a plan view showing the first spring member for generating an urging force and the like, FIG. 3(C) is an explanatory view showing a stopper mechanism, and FIG. 3(D) is an explanatory view showing a shutter plate.

FIG. 4 is a plan view showing the state where the door is at a half-opened position in a door opening and closing assisting device in accordance with an embodiment of the present invention.

FIG. 5 is a plan view showing the state where the door is at a full-opened position in a door opening and closing assisting device in accordance with an embodiment of the present invention.

FIG. 6 is an explanatory view showing the state where the restriction of a relay member is released by a stopper member in a door opening and closing assisting device in accordance with an embodiment of the present invention.

FIGS. 7(A) and 7(B) are explanatory plan views showing the effect of the door opening and closing assisting device shown in FIG. 6.

### DETAILED DESCRIPTION OF THE PREFERRED EMBODIMENTS

Embodiments of the present invention will be described below with reference to the accompanying drawings.

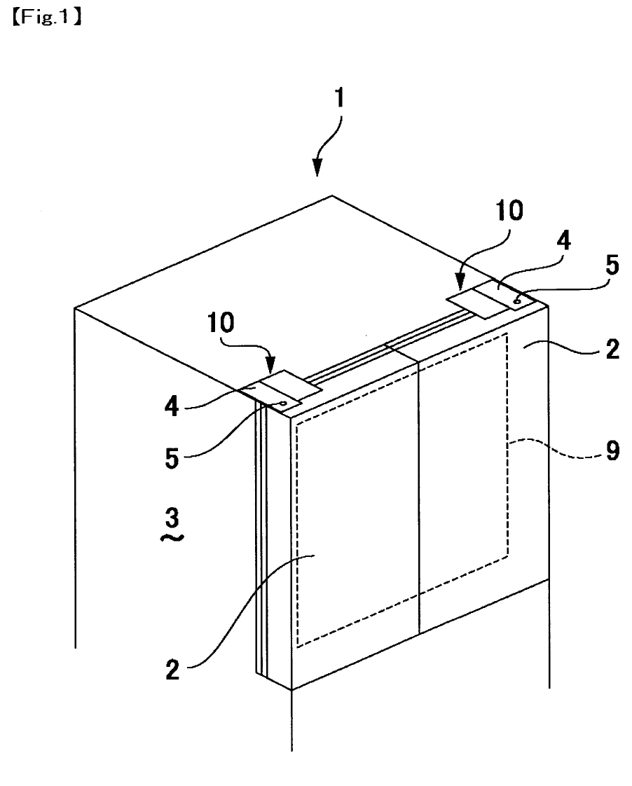

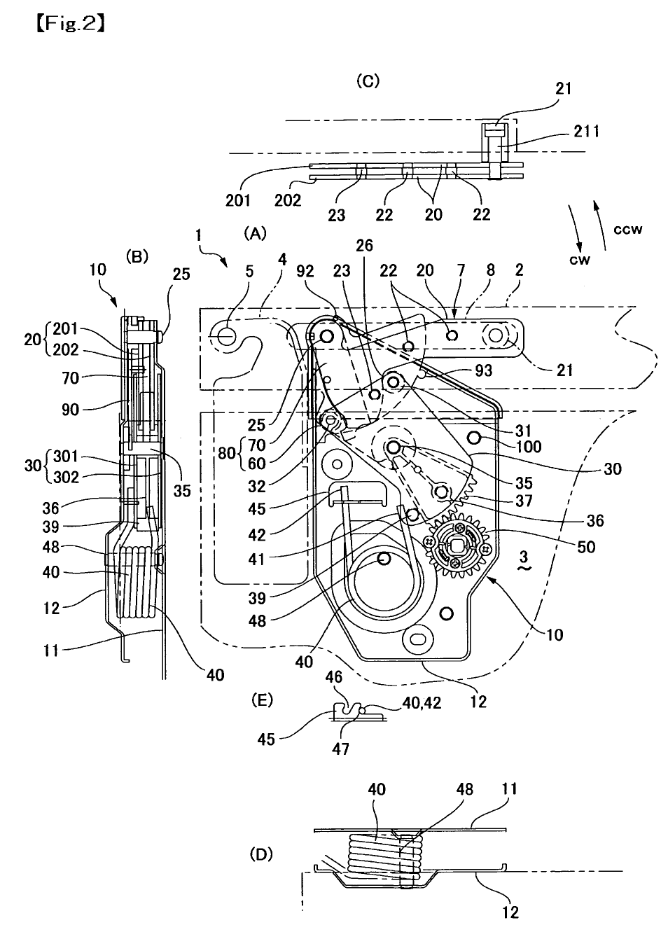

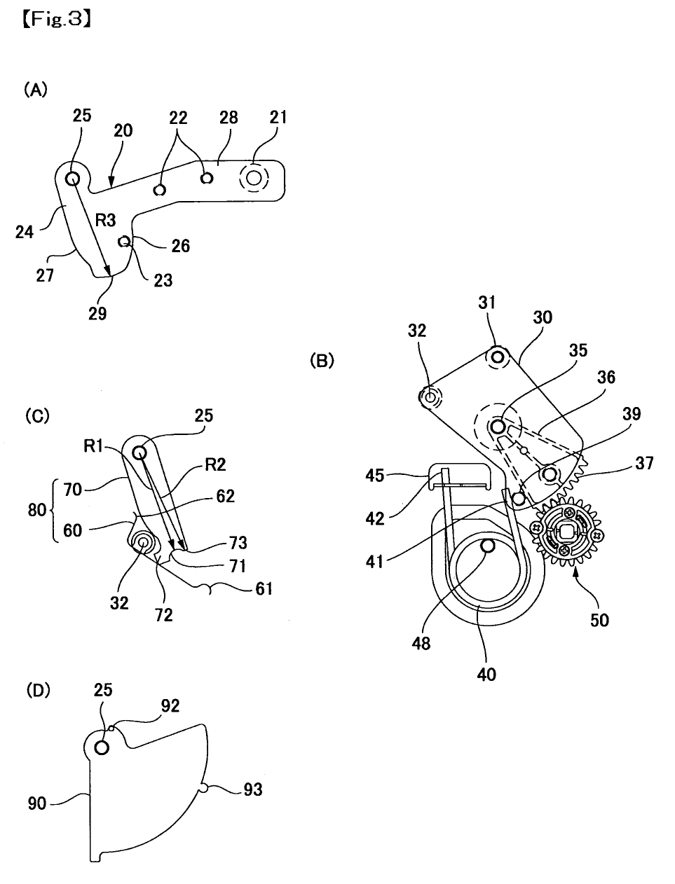

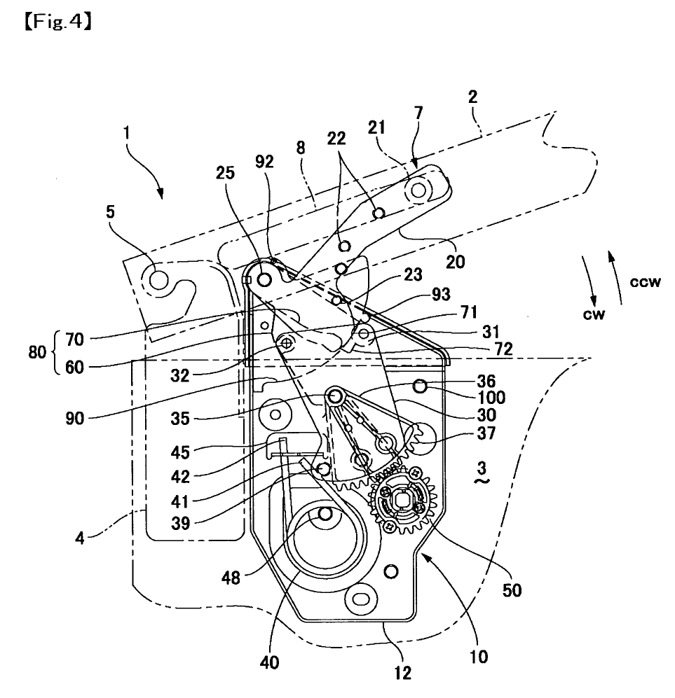

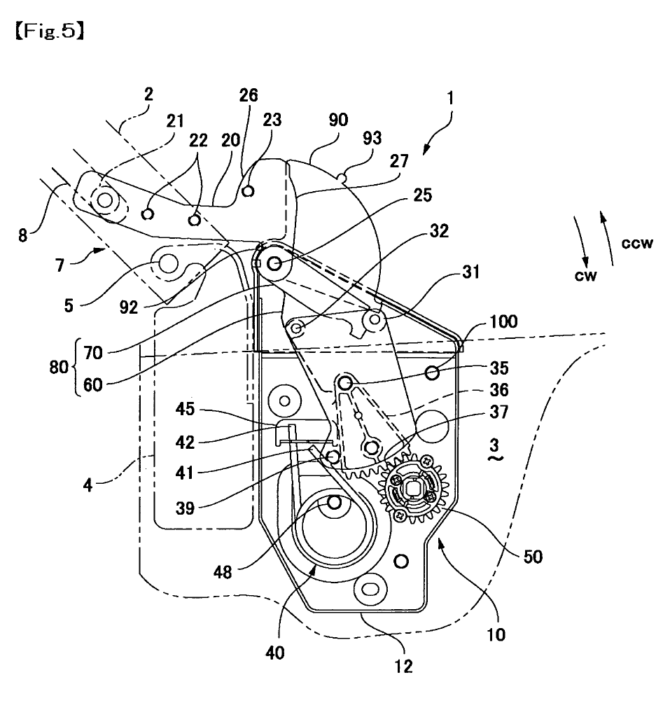

FIG. 1 is an explanatory view showing a refrigerator in which a door opening and closing assisting device in accordance with an embodiment of the present invention is mounted. FIG. 2(A) is an explanatory plan view showing the structure of a door opening and closing assisting device in accordance with an embodiment of the present invention, FIG. 2(B) is its longitudinal sectional view, FIG. 2(C) is a sectional view showing a lever member, FIG. 2(D) is a sectional view showing a first spring member for generating an urging force, and FIG. 2(E) is an explanatory view showing an urging force adjustment part. FIG. 3(A) is a plan view showing a lever member which is used in a door opening and closing assisting device in accordance with an embodiment of the present invention, FIG. 3(B) is a plan view showing the first spring member for generating an urging force and the like, FIG. 3(C) is an explanatory view showing a stopper mechanism, and FIG. 3(D) is an explanatory view showing a shutter plate. In the description below, the position of a door shown in FIG. 2(A) is a completely closed position, the position shown in FIG. 4 when the door is swung from the completely closed position by a specified angle in an open direction (counterclockwise direction) is a half-opened position, and the position shown in FIG. 5 when the door is further swung from the half-opened position in the open direction (counterclockwise direction) is a full opened position.

A refrigerator 1 shown in FIG. 1 is provided with a refrigerator main body 3 and a pair of double swing doors 2 for opening or closing its opening part 9. The pair of doors 2 is connected to the refrigerator main body 3 through respective hinge mechanisms 5 so as to be capable of opening or closing the opening part 9 of the refrigerator main body 3. In the refrigerator 1 in accordance with an embodiment of the present invention, door opening and closing assisting devices 10 are respectively constructed on its upper face to assist closing operation of the pair of doors 2.

In an embodiment of the present invention, as shown in FIG. 2(A), a door support plate 4 is fixed on the upper face of the refrigerator main body 3 and the door 2 is supported at its tip end part through the hinge mechanism 5. The door opening and closing assisting device 10 includes, as shown in FIGS. 2(A) and 2(B), a base plate 11 fixed to the upper face of the refrigerator 1 and a base plate 12 disposed oppositely to the base plate 11. The base plates 11, 12 are fixed to each other with connecting shafts 25, 35, 48, 100 and the like.

In FIGS. 2(A) and 2(B) and FIGS. 3(A) through 3(D), the door opening and closing assisting device 10 includes a lever member 20 which swings in cooperation with the opening and closing operation of the door 2, a first spring member 40 for generating an urging force to apply the urging force to the door 2 in a closing direction, and a stopper mechanism 80 which changes to the state where the first spring member 40 and the lever member 20 are mechanically connected to each other and to the state where their connection is released. In an embodiment of the present invention, the lever member 20 and the first spring member 40 are mechanically connected through a relay member 30. In this embodiment, a switching mechanism performing a function described later is constructed by the relay member 30 and the stopper mechanism 80.

The structure of respective members which are used in the door opening and closing assisting device 10 will be successively described below. First, as shown in FIGS. 2(A), 2(B) and 2(C) and FIG. 3(A), the lever member 20 is constructed by a pair of plate members 201, 202 which are oppositely faced via a prescribed space with a plurality of connecting shafts 22, 23. The lever member 20 is rotatably supported in a clockwise direction CW and in a counterclockwise direction CCW around a rotation center shaft 25 which is fixed between the base plates 11, 12. The rotation center shaft 25 is disposed at a side portion of the rotation center shaft of the hinge mechanism 5 which is the rotation center of the door 2 and both the positions of the rotation center shaft 25 and the hinge mechanism 5 are displaced.

The lever member 20 is provided with a base part 24 disposed on a rotation center shaft 25 side and an extended part 28 extended from the base part 24. A support shaft 211 protrudes downward from the under face of the extended part 28. A roller 21 is supported at a lower end portion of the support shaft 211 so as to be rotatable around the axial line of the support shaft 211. A guide groove 8 (guide part) is formed on the upper face of the door 2 and the roller 21 of the lever member 20 is disposed in the guide groove 8 in a movable manner. Therefore, in an embodiment of the present invention, a transmission mechanism 7 for interlocking the lever member 20 with the door 2 is constructed by the guide groove 8 and the roller 21. The base part 24 of the lever member 20 is provided with a first cam part 26 for transmitting opening and closing operation which is curved so that its radius is gradually increased and another first cam part 29 for transmitting opening and closing operation which is formed so as to be gradually increased to be a maximum radius portion from the first cam part 26. The first cam part 26 and the other first cam part 29 are formed on the outer peripheral edge part of a portion which is apart from the rotation center shaft 25.

As shown in FIGS. 2(A) and 2(B) and FIG. 3(B), a relay member 30 constructing a switching mechanism is constructed by a pair of roughly rectangular plate members 301, 302 which are oppositely faced via a prescribed space with a connecting shaft. The relay member 30 is rotatably supported in the clockwise direction CW and the counterclockwise direction CCW on the rotation center shaft 35 that is fixed between the base plate 11 and the base plate 12. A roller 31 is supported by a support shaft at one of four corner portions of the relay member 30. The roller 31 abuts with the first cam part 26 for transmitting opening and closing operation of the lever member 20. Further, a connecting shaft 39 of the relay member 30 which is located on the opposite side of the roller 31 with respect to the rotation center shaft 35 is formed as an operation part to the first spring member 40 described later.

As shown in FIGS. 2(A) and 2(B) and FIG. 3(B), a roughly fan shaped gear 36 is fixed between the pair of plate members 301, 302 of the relay member 30. An oil type of damper device 50 is disposed at a side portion of the relay member 30. The outer teeth constructed on the outer peripheral portion of the damper device 50 engages with the teeth part 37 of the gear 36. The damper device 50 is constructed such that a square shaft part disposed on its center side is prevented from being rotated by the base plates 11, 12 and its outer peripheral side is formed as a rotating part and a damper mechanism is assembled between the square shaft part and the rotating part. The damper mechanism is constructed such that a load is not applied when the rotating part on its outer peripheral side is rotated in the counterclockwise direction CCW and a load is applied when the rotating part is rotated in the clockwise direction CW. Further, in an embodiment of the present invention, a load by the damper is set to be changed in accordance with its rotation angle.

As shown in FIG. 2(D) and FIG. 3(B), the first spring member 40 composed of a coil spring is disposed at a side portion of the relay member 30. The first spring member 40 is engaged with a spring positioning shaft 48 disposed on its inner side, an urging force adjusting part 45 with which one side edge part 42 is engaged, and the connecting shaft 39 of the relay member 30 with which the other edge part 41 is abutted.

As shown in FIG. 2(E) and FIG. 3(B), the urging force adjusting part 45 is constructed of an L-shaped plate and two grooves 46, 47 are formed on the upper face of the rising part of the urging force adjusting part 45. Therefore, in the urging force adjusting part 45, the urging force of the first spring member 40 can be adjusted by changing the position where the one side end part 42 of the first spring member 40 is engaged with either of two grooves 46, 47.

As shown in FIGS. 2(A) and 2(B) and FIG. 3(C), the stopper mechanism 80 is composed of a plate shaped stopper member 70 disposed between the pair of plate members 201, 202 constructing the lever member 20 and a second spring member 60 for pressing the stopper member which is constructed to press the stopper member 70 in the counterclockwise direction CCW. The stopper member 70 is rotatably supported by the rotation center shaft 25 in the clockwise direction CW and the counterclockwise direction CCW like the lever member 20. The second spring member 60 is a leaf spring whose central portion in its longitudinal direction is supported by the connecting shaft 32 of the relay member 30 and is rotatable around the connecting shaft 32 in the clockwise direction CW and the counterclockwise direction CCW. The base end portion 61 of the second spring member 60 abuts with the center portion of the gear 36 disposed on the relay member 30 and, when the relay member 30 is rotated in the clockwise direction CW, the tip end portion 62 of the second spring member 60 presses the edge part on the clockwise direction CW side of the stopper member 70.

In an embodiment of the present invention, when the radius of the other first cam part 29 which is adjacent to the first cam part 26 of the lever member 20 in the clockwise direction CW is set to be R3 (see FIG. 3(A)), the radius of a shallow recessed part 71 which is formed on the outer peripheral portion of the stopper member 70 is set to be R1 (see FIG. 3(C)), and the radius of a circular arc part 73 which is adjacent to the recessed part 71 in the counterclockwise direction CCW is set to be R2 (see FIG. 3(C)), the relationship between the R1, R2 and R3 is set to be R1<R2<R3. Further, a protruded part 72 is formed on the portion which is adjacent to the recessed part 71 in the clockwise direction CW.

As shown in FIGS. 2(A) and 2(B) and FIG. 3(D), in the door opening and closing assisting device 10 in accordance with an embodiment of the present invention, a fan-shaped shutter plate 90 is disposed between the lever member 20 and the base plate 12. The shutter plate 90 is rotatably supported around the rotation center shaft 25 in the clockwise direction CW and in the counterclockwise direction CCW like the stopper member 70 and the lever member 20. The shutter plate 90 is provided with a protruded part 92 formed near its rotation center and a protruded part 93 formed on its outer peripheral circular arc portion. The height dimensions of the protruded parts 92, 93 are set to be capable of abutting with the lever member 20. Therefore, when the lever member 20 is swung in the counterclockwise direction CCW, the base part 24 of the lever member 20 abuts with the protruded part 92 and the shutter plate 90 is swung in the counterclockwise direction CCW. On the contrary, when the lever member 20 is swung in the clockwise direction CW, the center side portion of the extended part 28 of the lever member 20 abuts with the protruded part 93 and the shutter plate 90 is swung in the clockwise direction CW. The width in the rotational direction between the protruded parts 92, 93 of the shutter plate 90 is set to be larger than the width in the rotational direction of the lever member 20 and thus the shutter plate 90 interlocks with the lever member 20 later than the operation of the lever member 20.

FIG. 4 is a plan view showing the state where the door is at a half-opened position and FIG. 5 is a plan view showing the state where the door is at a full-opened position in the door opening and closing assisting device in accordance with an embodiment of the present invention.

In the door opening and closing assisting device 10 and the refrigerator 1 in accordance with an embodiment of the present invention, when the door 2 is swung from the state shown in FIG. 2(A) to the half-opened position shown in FIG. 4 in the counterclockwise direction CCW, the lever member 20 is swung around the rotation center shaft 25 in the counterclockwise direction CCW while the roller 21 moves in the guide groove 8. At this time, the lever member 20 and the relay member 30 are mechanically connected to each other through the first cam part 26 and the roller 31. Therefore, when the lever member 20 swings, the roller 31 moves along the first cam part 26 and the relay member 30 swings around the rotation center shaft 35 in the clockwise direction CW. As a result, the other edge part 41 of the first spring member 40 is pressed by the connecting shaft 39 of the relay member 30 and the first spring member 40 is forcibly urged and elastically deformed. At the same time, the outer peripheral portion of the damper device 50 is rotated by the gear 36 in the counterclockwise direction CCW but the damper device 50 does not generate a load during the rotation in this counterclockwise direction.

The base end portion of the second spring member 60 for pressing the stopper member is pressed by the gear 36 and is swung around the connecting shaft 32 in the clockwise direction CW. Therefore, the tip end portion 62 of the second spring member 60 presses the edge portion on the clockwise direction CW side of the stopper member 70. As a result, the stopper member 70 is swung around the rotation center shaft 25 in the counterclockwise direction CCW so as to follow the lever member 20. In this state, since the stopper member 70 abuts with the connecting shaft 23 of the lever member 20, the stopper member 70 does not go ahead of the lever member 20 in the counterclockwise direction CCW.

When the door is at the half-opened position shown in FIG. 4, the roller 31 of the relay member 30 is fitted into the recessed part 71 formed on the outer peripheral portion of the stopper member 70 by the other first cam part 29 of the lever member 20. The shutter member 90 has not abutted with the lever member 20 until this state and thus the shutter member 90 does not move as shown in FIG. 2(A) and FIG. 4.

Next, when the door 2 is further swung from the half-opened position shown in FIG. 4 to the full-opened position shown in FIG. 5 in the counterclockwise direction CCW, the lever member 20 is further swung in the counterclockwise direction CCW around the rotation center shaft 25 while the roller 21 moves in the guide groove 8. In this case, the other first cam part 29 of the lever member 20 moves away from the roller 31 of the relay member 30 and the roller 31 is fitted into the recessed part 71 and abuts with the protrusion part 72 which are formed on the outer peripheral portion of the stopper member 70. In the state where the roller 31 of the relay member 30 is fitted into the recessed part 71 of the stopper member 70, the forces applied to the relay member 30 and the stopper member 70 are in an equilibrium state. Therefore, even when the lever member 20 is further swung in the counterclockwise direction CCW around the rotation center shaft 25, the stopper member 70 remains to be stopped at the position shown in FIG. 4. Accordingly, even when the lever member 20 is further swung in the counterclockwise direction CCW around the rotation center shaft 25, the relay member 30 is restricted by the stopper member 70 to keep its stopped state and the mechanical connection between the lever member 20 and the relay member 30 is disconnected. Consequently, the first spring member 40 is maintained in the state where the first spring member 40 is forcibly urged and elastically deformed.

At this time, the outer peripheral portion of the damper device 50 is rotated in the counterclockwise direction CCW by the gear 36 but, during the rotation in this direction, the damper device 50 does not apply a load. Further, since the protruded part 92 of the shutter member 90 is pressed by the lever member 20 in the counterclockwise direction CCW, the shutter member 90 is swung in the counterclockwise direction CCW around the rotation center shaft 25 to cover a space formed between the refrigerator main body 3 and the door 2 as shown in FIG. 5.

As described above, in an embodiment of the present invention, the stopper mechanism 80 composed of the stopper member 70 and the second spring member 60 permits the mechanical connection between the first cam part 26 and the relay member 30 while the door 2 is located between the completely closed position and the half-opened position. In addition, when the door 2 is further swung in the open direction from the half-opened position, the stopper mechanism 80 restricts the relay member 30 to keep the first spring member 40 in the forcibly urged and elastically deformed state. Accordingly, the switching mechanism which is constructed of the stopper mechanism 80 and the relay member 30 causes the lever member 20 and the first spring member 40 to connect mechanically to each other while the door 2 is located between the completely closed position and the half-opened position. Further, when the door 2 is further swung in the open direction from the half-opened position, the switching mechanism disconnects the mechanical connection between the lever member 20 and the first spring member 40 while the first spring member 40 is maintained to be forcibly urged and elastically deformed.

Next, when the door 2 is swung in the clockwise direction CW from the full-opened position shown in FIG. 5 toward the half-opened position shown in FIG. 4, the lever member 20 is swung in the clockwise direction CW around the rotation center shaft 25 while the roller 21 moves in the guide groove 8. At this time, the stopper member 70 remains to be stopped at the position shown in FIG. 5 and the relay member 30 remains to be restricted by the stopper member 70, and thus the mechanical disconnection between the lever member 20 and the relay member 30 is maintained. Therefore, the first spring member 40 is maintained to be forcibly urged and elastically deformed.

Also, when the lever member 20 is swung in the clockwise direction CW around the rotation center shaft 25, the lever member 20 abuts with the protruded part 93 of the shutter member 90 on the way. Therefore, the shutter member 90 is swung in the clockwise direction CW together with the lever member 20 from the halfway.

Next, when the door 2 is further swung in the clockwise direction CW from the half-opened position shown in FIG. 4 to the completely closed position shown in FIG. 2(B), the lever member 20 is swung in the clockwise direction CW around the rotation center shaft 25 while the roller 21 moves in the guide groove 8. In this case, the other first cam part 29 of the lever member 20 abuts with the roller 31. In an embodiment of the present invention, the radius “R3” of the other first cam part 29 is set to be R3>R1 as described above, and thus the other first cam part 29 receives the elastic force urged by the first spring member 40 instead of the stopper member 70. Immediately after that, the return force of the first spring member 40 is applied through the roller 31 from the cam part 29 to the first cam part 26. In this case, since the connecting shaft 23 of the lever member 20 presses the stopper member 70, the stopper member 70 is swung in the clockwise direction CW together with the lever member 20. In this manner, the roller 31 of the relay member 30 abuts with the first cam part 26 of the lever member 20 and thus the relay member 30 and the lever member 20 are mechanically connected.

Therefore, after that, since the restriction of the relay member 30 is released, the first spring member 40 applies a force to swing the relay member 30 in the counterclockwise direction CCW by its elastic return force. This force is transmitted to the lever member 20 through the roller 31 and the first cam part 26. Therefore, the elastic return force through the relay member 30 urges the door 2 in its closing direction. The urging force of the first spring member 40 is sufficiently larger than that of the second spring member 60 which apply a force to swing the lever member 20 in the counterclockwise direction CCW through the stopper member 70. Consequently, a user is capable of closing the door 2 only by applying a little force to the door 2. Further, the lever member 20 is capable of further turning on an inner side from the completely closed position and thus the return force of the first spring member 40 remains to apply the lever member 20. As a result, the door 2 can be surely closed.

Further, the force which swings the relay member 30 in the counterclockwise direction CCW rotates the outer peripheral portion of the damper device 50 through the gear 36 in the clockwise direction CW. During the rotation in this direction, since the damper device 50 generates a load, the door 2 is closed slowly.

In addition, when the door 2 is going to be closed rapidly, the edge part 27 (see FIG. 3(A)) of the lever member 20 presses the connecting shaft 32 of the relay member 30 to turn the relay member 30 in the counterclockwise direction CCW. Therefore, when the door 2 is going to be closed with a large force, the lever member 20 causes the relay member 30 to swing directly and thus the transmission of a turning force of the lever member 20 and the switching mechanism (stopper mechanism 70 and relay member 30) is surely performed. Further, since the damper device 50 is operated, the door 2 can be prevented from closing rapidly.

As described above, in the door opening and closing assisting device 10 in this embodiment of the present invention, the first spring member 40 for generating an urging force is forcibly urged and elastically deformed in a region where the door 2 is swung from the completely closed position to the half-opened position. In addition, when the door 2 is further opened, the switching mechanism (stopper mechanism 80 and relay member 30) disconnects the mechanical connection between the lever member 20 and the first spring member 40 while the first spring member 40 is maintained in a state to be forcibly urged and elastically deformed. Therefore, in the state where the door 2 is widely opened, foods can be easily put in and taken out because an urging force is not applied to the door 2. Further, in the case that the door 2 is closing, when the door 2 reaches to the half-opened position, the switching mechanism causes the lever member 20 and the first spring member 40 to connect in a mechanical manner and thus the urging force of the first spring member 40 is applied to the door 2. Therefore, the door 2 can be easily and surely closed. In addition, in this embodiment of the present invention, all the lever member 20, the first spring member 40 and the switching mechanism are mounted on the refrigerator main body 3 side. Therefore, the timing when the urging force is applied to the door 2 can be easily adjusted with a relatively simple structure, which is different from the case in which these members are separated so as to be disposed on both the refrigerator main body 3 side and the door 2 side. Consequently, according to the door opening and closing assisting device 10 in this embodiment of the present invention, its assembly is easy and the door 2 can be easily and surely closed with a secure or preferable feeling.

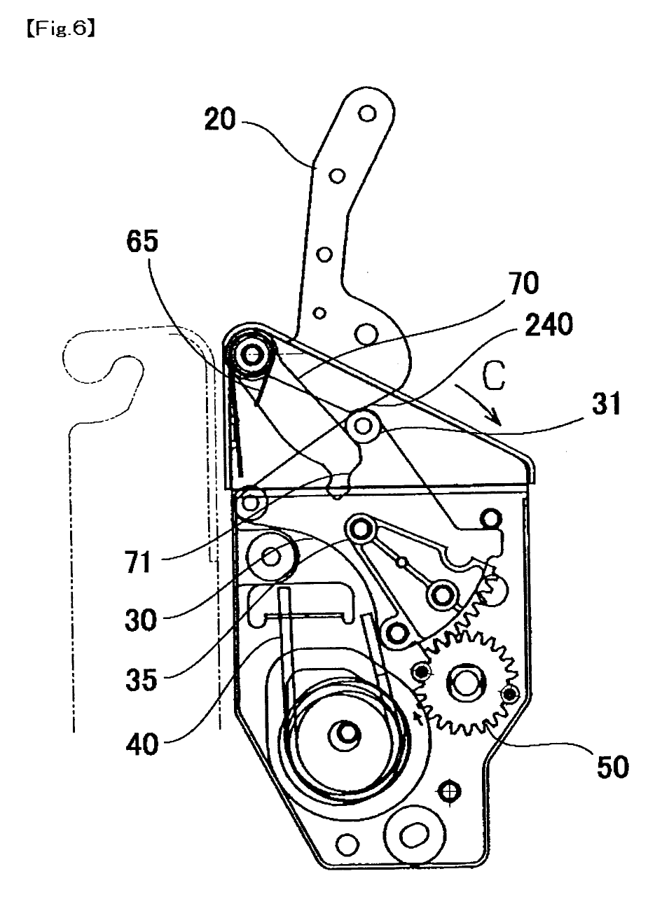

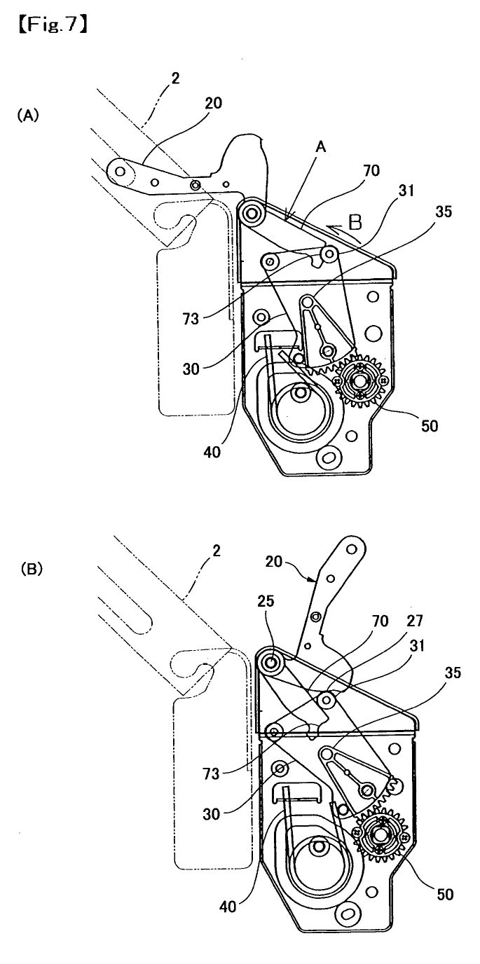

FIG. 6 is an explanatory view showing the state where the restriction of a relay member is released by a stopper member in a door opening and closing assisting device in accordance with another embodiment of the present invention. FIGS. 7(A) and 7(B) are explanatory views showing the effect of the door opening and closing assisting device shown in FIG. 6.

In an embodiment of the present invention described above, the stopper member 70 and the second spring member 60 for pressing the stopper member are used as the stopper mechanism 80 as shown in FIGS. 2(A) and 2(B) and FIG. 3(C). However, as shown in FIG. 6, a stopper member 70 and another second spring member 65 for pressing the stopper member which is composed of a torsion coiled spring and urges the stopper member 70 in the counterclockwise direction CCW around the connecting part 25 may be used in an embodiment of the present invention.

Further, the lever member 20 is provided with a second cam part 240 for pressing the relay member 30, which presses back the relay member 30 to the position where the door 2 is capable of performing a closing operation when the closing operation of the door 2 is performed. According to the construction described above, as shown in FIG. 6, when the stopper member 70 restricting the relay member 30 is displaced by an external force to release the restriction of the relay member 30 and the relay member 30 is moved to the position where the closing operation of the door 2 is obstructed, the second cam part 240 presses back the relay member 30 to the position where the door 2 is capable of performing a closing operation. In this embodiment of the present invention, the shape of the relay member 30 and the position of the roller 31 is changed from the above-mentioned embodiment.

As a comparison example, in the door opening and closing operation assisting device 1 described in FIGS. 1 through 5, when the door 2 is opened as shown in FIG. 7(A), the roller 31 of the relay member 30 is restricted by the stopper member 70 so that the door 2 is not urged in the closing direction. In this state, when the stopper member 70 is swung in the clockwise direction CW by an external force applied to the stopper member 70 in the direction as shown by the arrow “A”, the restriction of the roller 31 of the relay member 30 by the stopper member 70 is released. As a result, the relay member 30 is swung in the counterclockwise direction CCW around the connecting shaft 35 and the roller 31 is displaced in the direction as shown by the arrow “B” to reach to the state as shown in FIG. 7(B). In this state, when the door 2 is closed, the edge part 27 of the lever member 20 interferes with the roller 31 and the closing operation of the door 2 is obstructed. However, in this embodiment of the present embodiment, as shown in FIG. 6, the second cam part 240 for pressing the relay member is formed in the lever member 20. Therefore, even when the roller 31 of the relay member 30 is displaced to the position where the closing operation of the door 2 is obstructed, the second cam part 240 pushes the roller 31 to make the relay member 30 swing in the direction shown by the arrow “C” with a relatively stronger force which is applied to the door 2 in the closing direction. As a result, the roller 31 of the relay member 30 is moved to the position where the closing operation of the door 2 is not obstructed. Further, the stopper member 70 is pressed by the other second spring member 65 to be swung in the counterclockwise direction CCW around the connecting shaft 25. Therefore, the roller 31 of the relay member 30 fits into the recessed part 71 and the state where the roller 31 of the relay member 30 is restricted is returned. Accordingly, after that, the closing operation of the door 2 can be performed without a problem and, at this time, the urging force of the first spring member 40 is applied to the door 2 through the relay member 30 in the closing direction.

In the embodiment of the present invention described above, the first spring member 40 for generating an urging force is constructed of a torsion coiled spring. However, a spiral spring or a compression spring may be used. Further, the second spring member 60 for pressing the stopper member is composed of a leaf spring but a torsion coil spring or a tension coil spring may be used. An air damper device may be used as the damper device.

In the embodiment of the present invention described above, the lever member 20, the first spring member 40 and the switching mechanism (stopper mechanism 80 and relay member 30) are unitized and constructed on the refrigerator main body 3 side. However, these members may be disposed on the door 2 side. Further, in the embodiment of the present invention described above, the door opening and closing assisting device 10 is applied to a double swinging doors type of refrigerator. However, the present invention may be applied to a refrigerator with a single swing door or other apparatuses.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A door opening and closing assisting device for assisting a closing operation of a door which is connected to a main body of an apparatus through a hinge mechanism to open or close an aperture part formed in the main body of the apparatus comprising:
a lever member which is swung in cooperation with an opening and closing operation of the door;
a first spring member for generating an urging force which is elastically deformed by a swing motion of the lever member when the door is swung in an open direction and which urges the door by an elastic return force in a closing direction through the lever member; and
a switching mechanism which mechanically connects the lever member to the first spring member in response to the door being between a completely (closed position and a half-opened position where the door is swung by a prescribed angle in an open direction from the completely closed position and which releases the mechanical connection between the lever member and the first spring member maintaining the first spring member in a state where the first spring member is forcibly urged and elastically deformed in response to the door being at a further opened position from the half-opened position;
wherein the lever member, the first spring member and the switching mechanism are arranged on one of the door and the main body of the apparatus.

2. The door opening and closing assisting device according to claim 1, wherein the lever member, the first spring member and the switching mechanism are arranged on the main body of the apparatus.

3. The door opening and closing assisting device according to claim 1, wherein the switching mechanism comprises:
a first cam part, for transmitting an opening and closing operation, which is formed in the lever member;
a relay member which is displaced by the first cam part to make the first spring member elastically deform while the door is located between the completely closed position and the half-opened position and which is capable of transmitting an elastic return force generated by the first spring member being elastically deformed to the lever member through the first cam part; and
a stopper mechanism which permits the mechanical connection between the first cam part and the relay member while the door is located between the completely closed position and the half-opened position and which keeps the first spring member in a state where the first spring member is forcibly urged and elastically deformed by restricting the relay member when the door is located at a further opened position from the half-opened position.

4. The door opening and closing assisting device according to claim 3, wherein the stopper mechanism comprises:
a stopper member which keeps the first spring member in the state where the first spring member is forcibly urged and elastically deformed by restricting the relay member when the door is located at a further opened position from the half-opened position; and
a second spring member for pressing the stopper member for displacing the stopper member to a position where the relay member is restricted.

5. The door opening and closing assisting device according to claim 4, wherein the stopper member is swung around a common rotation center axis with the lever member and is displaced to the position where the relay member is restricted.

6. The door opening and closing assisting device according to claim 4, wherein the lever member is provided with a second cam part for pressing the relay member which presses the relay member back to a position to enable a closing operation of the door when the stopper member restricting the relay member is displaced by an external force and releases the restriction of the relay member and the relay member moves to a position obstructing the closing operation of the door.

7. The door opening and closing assisting device according to claim 6, wherein the second cam part for pressing the relay member is formed so as to press the relay member back to a position where the stopper member is restricted, and the stopper member is returned to a state which is capable of restricting the relay member by the second spring member being pressed.

8. The door opening and closing assisting device according to claim 3, further comprising a damper device which is mechanically connected to the relay member for generating a load when the door is swung in a closing direction.

9. The door opening and closing assisting device according to claim 8, wherein the lever member causes the relay member to swing in a direction in which the damper device generates a load when the door is swung in the closing direction.

10. The door opening and closing assisting device according to claim 1, further comprising a shutter member which is moved to cover a portion between the door and the main body of the apparatus in cooperation with the lever member when the door is swung in an open direction.

11. The door opening and closing assisting device according to claim 1, further comprising a transmission mechanism for interlocking the door with the lever member, which includes a roller and a guide part that guides the roller.

12. A method of assisting in opening and closing a door of a main body apparatus, the method comprising:
elastically deforming a first spring member in response to the door being opened from a completely closed to a half-opened position;
disconnecting the urging force of the still elastically deformed first spring member from urging the door in a closed direction in response to the door being opened beyond the half-opened position; and
reconnecting the urging force of the still elastically deformed first spring member with the door to urge the door in a closed direction, in response to the door being half-opened or less than half-opened.

13. The method of assisting in opening and closing a door of a main body apparatus of claim 12, the method further comprising:
dampening the speed at which the door closes in response to the urging force of the first spring element.
